(19) United States
(12) Patent Application Publication
(10) Pub. No.: US 2014/0052332 A1
(43) Pub. Date: Feb. 20, 2014

(54) TPMS CONNECTED TO PROPULSION SYSTEM

(71) Applicants: Juan Armando Hernandez Jimenez, Zapopan (MX); Jose Dario Rizo Barbosa, Zapopan (MX); Octavio Chiman Amador, Japopan (MX)

(72) Inventors: Juan Armando Hernandez Jimenez, Zapopan (MX); Jose Dario Rizo Barbosa, Zapopan (MX); Octavio Chiman Amador, Japopan (MX)

(73) Assignee: CONTINENTAL AUTOMOTIVE SYSTEMS, INC., Auburn Hills, MI (US)

(21) Appl. No.: 13/584,884

(22) Filed: Aug. 14, 2012

(51) Int. Cl. G06F 17/00; B60C 23/02

(52) U.S. Cl. CPC G06F 17/00; B60C 23/02
USPC 701/36; 340/442

(57) ABSTRACT

A tire pressure monitoring system which is linked to the control unit or other control device of a vehicle which limits the operation, or completely disables the operation of, the vehicle when the pressure in one or more of the tires of the vehicle is insufficient. The operation of the vehicle may be limited so as to completely disable the operation of the engine, transmission, or a combination of both. The rotational speed of the engine may be limited, or the operation of the transmission may be limited. A combination of limitations may be placed on both the engine and transmission, to prohibit the vehicle from being operated at unsafe speeds due to the tire pressure in one or more of the tires being at an undesirable level.

### FIELD OF THE INVENTION

The invention relates generally to a tire pressure monitoring system, and more particularly, to a tire pressure monitoring system which limits the operation of or disables the propulsion system of a vehicle.

### BACKGROUND OF THE INVENTION

Monitoring pressure in the tires of a vehicle functions to not only ensure the safety of the driver or operator of the vehicle, but also to facilitate the vehicle having optimal fuel economy. Tire pressure monitoring systems (TPMS) are incorporated to cars, trucks, sport-utility vehicles, motorcycles, semi-trucks, tractors, and the like. A sudden or gradual loss of tire pressure presents a danger to the driver of any vehicle, and the incorporation of a TPMS provides a warning to the driver to attend to the reduced amount of pressure in one or more of the tires.

In some instances, such as motorcycles, it is more difficult to sense or “feel” when the tire pressure is low, which presents a danger. It is particularly difficult to notice when the tire pressure is low when the motorcycle is travelling at high speeds, and it is more dangerous to travel at high speeds with low tire pressure. Additionally, some drivers may choose to ignore the warning provided by a TPMS, and continue to drive the vehicle in an unsafe condition. This not only presents a danger to the driver of the vehicle, but also presents the danger of an accident to other drivers of other vehicles as well. Accordingly, there exists a need for a TPMS which is incorporated into the operation of the vehicle which disallows or limits the operation of the vehicle when the vehicle is unsafe to drive.

### SUMMARY OF THE INVENTION

The present invention is a system for signaling an indication of insufficient pressure in one or more tires of a vehicle. The system includes a tire pressure monitoring system (TPMS) having a plurality of pressure sensors and a first control unit. The system also includes plurality of tires, each one of the plurality of pressure sensors mounted to a corresponding one of the plurality of tires, and the first control unit of the TPMS is in communication with each of the plurality of sensors such that the first control unit receives a signal from one or more of the plurality of pressure sensors indicating that one or more of the plurality of tires has an undesired pressure.

A second control unit is in communication with the first control unit, such that the second control unit receives the signal from the first control unit that one or more of the plurality of tires has an undesired pressure. A warning device is controlled by the second control unit, to provide an indication to the driver of the vehicle that one or more of the plurality of tires has an undesired pressure. At least one light, which is capable of functioning as a hazard light, is mounted to the vehicle. A propulsion unit, such as an engine and transmission, is controlled by the second control unit, and the light is activated to operate as a hazard light by the second control unit when the one or more of the plurality of pressure sensors detects an undesired pressure level in one or more of the tires.

Accordingly, it is an object of the invention to provide a tire pressure monitoring system which is linked to the control unit or other control device of a vehicle which limits the operation of or completely disables the operation of the vehicle when the pressure in one or more of the tires of the vehicle is insufficient.

One type of limitation of the operation of the vehicle is to completely disable the operation of the engine, transmission, or a combination of both. The rotational speed (rpm) of the engine may be limited, or the operation of the transmission may be limited. If the transmission is a multiple gear transmission, the transmission only may be allowed to shift up to a specific gear, such as second gear. A combination of limitations may be placed on both the engine and transmission, to limit the operation of the vehicle.

In one embodiment, once an undesirable amount of pressure is detected in one or more of the tires, the vehicle may be allowed to operate as normal until the vehicle comes to a stop. Once the vehicle comes to a stop, the operation of the engine, transmission, or a combination of both, may be limited to prohibit the vehicle from being operated at unsafe speeds due to the tire pressure in one or more of the tires being at an undesirable level.

The system of the present invention is for use with any type of vehicle where it is necessary to monitor the tire pressure. The system may be used with vehicle such as, but not limited to, motorcycles, cars, trucks, vans, semi-trucks, tractors, all-terrain vehicles, and the like.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is diagram of a vehicle having a system which is used for limiting the operation of the vehicle when one or more of a plurality of tires has an undesired pressure, according to the present invention;

FIG. 2 is a diagram of an instrument cluster having a warning device used with a system for limiting the operation of a vehicle when one or more of a plurality of tires has an undesired pressure, according to the present invention; and

FIG. 3 is a rear view of a vehicle navigating a curve, the vehicle having a system for limiting the operation of a vehicle when one or more of a plurality of tires has an undesired pressure, according to the present invention.

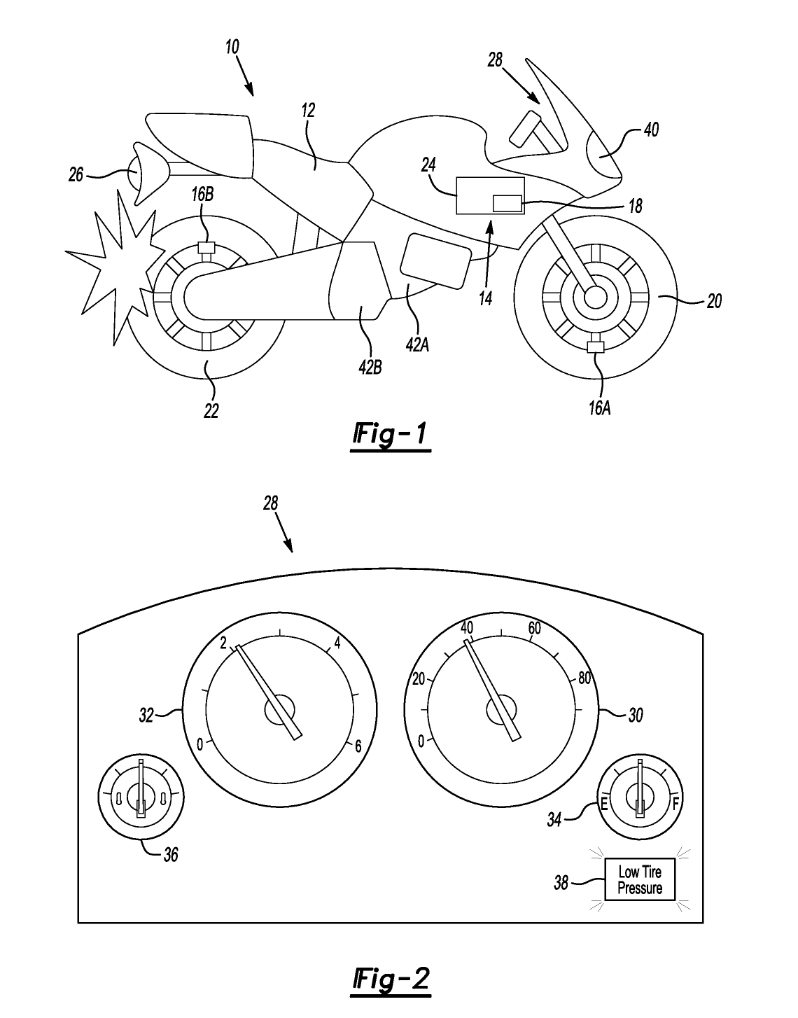

### DETAILED DESCRIPTION OF THE PREFERRED EMBODIMENTS

The following description of the preferred embodiment(s) is merely exemplary in nature and is in no way intended to limit the invention, its application, or uses.

A system, shown generally in the Figures at 10, according to the present invention is incorporated with the use of a vehicle 12. The system 10 includes a tire pressure monitoring system (TPMS) 14. The TPMS 14 includes two pressure sensors 16, and a first control unit 18. The control unit 18 is in wireless communication with the sensors 16, and the sensors 16 monitor pressure in the tires. More specifically, the first sensor 16A monitors pressure in the front tire 20, and the second sensor 16B monitors pressure in the rear tire 22.

In addition to a TPMS 14, the system 10 also includes a second control unit 24, which is the control unit 24 of the vehicle 12, which in one embodiment may be connected to the control unit 18, such that both control units 18,24 are one component. In other embodiments each control unit 18,24 may be a separate component, able to operate together, but not connected to one another.

The vehicle 12 is a motorcycle, and also includes rear lights 26 which may function as hazard lights, brake lights, or both. The rear lights 26 may be a combination of lights that include turn signals, which may also be used as hazard lights. The vehicle 12 also includes an instrument cluster, shown generally at 28, and best seen in FIG. 2, having various gauges, such as a speedometer 30, tachometer 32, fuel gauge 34, temperature gauge 36, and a warning device 38. The warning device 38 in one embodiment may be a light or lamp which functions as a “tell tale,” and includes an alarm sound to warn the driver that the pressure in one or both of the tires 20,22 is low. Mounted toward the front of the vehicle 12, in front of the instrument cluster 28, is a set of front lights 40, which function as hazard lights, headlights, or both, and may also be a combination of lights which include turn signals that may function as hazard lights as well.

In operation, the TPMS 14 functions to monitor pressure in both tires 20,22. If the pressure in one or more of the tires 20,22 is low, the control unit 18 receives a signal from one or both of the sensors 16A,16B, and the control unit 18 of the TPMS 14 communicates with the control unit 24 of the vehicle 12 by receiving a second signal from the control unit 18 of the TPMS 14. The control unit 24 then sends a third signal to the warning device 38 to alert the driver that one or both of the tires 20,22 is at a lower than desired pressure level. The warning device 38 may include one or both of a visible warning, such as a tell tale, and an alarm sound to warn the driver that the tire pressure is low. The warning device 38 may also be configured to provide an indication as to which one of the tires 20,22 is low in pressure.

The control unit 24 also commands the rear lights 26 and the front lights 40 to act as hazard lights or warning lights to warn drivers of other vehicles that the vehicle 12 is in an emergency condition. As mentioned above, the rear lights 26 may be a combination of brake light and turn signal lights, a combination of which may be used as hazard lights, and the rear lights 26 may also be a combination of headlights and turn signal lights, a combination of which may be used as hazard lights. Furthermore, the control unit 24 also controls the propulsion system of the vehicle 12, which in this embodiment is a combination engine/transmission 42A,B. The engine 42A may be gasoline powered, or electrically powered, but is still controlled by the control unit 24. The control unit 24 limits the operation of the engine 42A such that the vehicle 12 may only travel up to a limited speed, such as twenty miles per hour. This may be accomplished by limiting the rotational speed (rpm) of the engine 42A. The speed the vehicle 12 is limited to may be programmed into the control unit 24 by the manufacturer, and changed depending upon the laws of the country the vehicle 12 is sold in, or specified by the manufacturer. The control unit 24 may also be programmed to limit the operation of the transmission 42B, such as limiting the gears the transmission 42B may be shifted to.

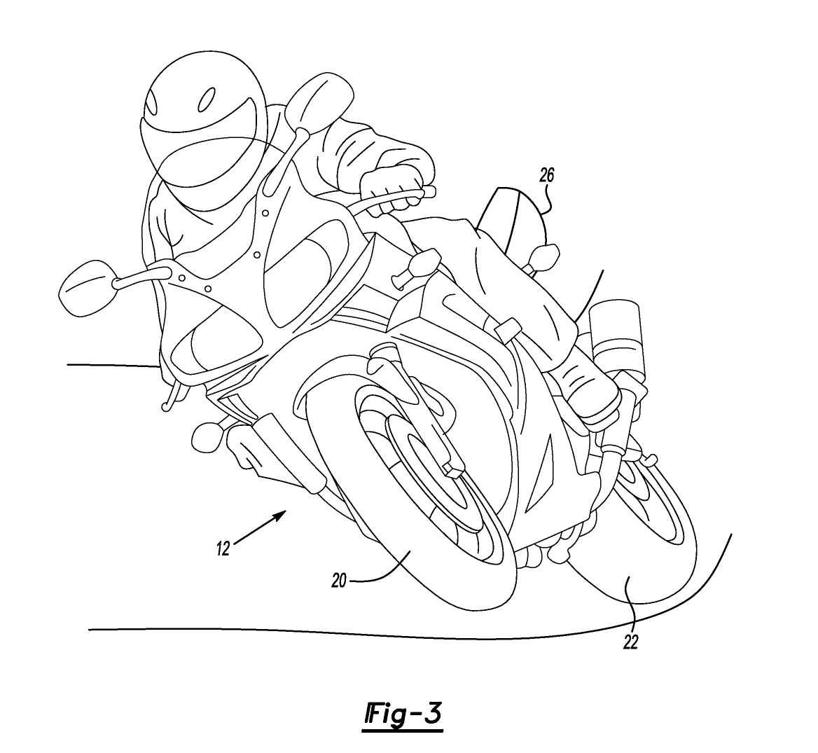

Furthermore, the vehicle 12 may be equipped with the appropriate sensor to detect when the vehicle 12 is navigating a curve, such as shown in FIG. 3. If the sensor detects that the vehicle 12 is navigating a curve, than no further action by the control unit 24 is taken until the vehicle 12 resumes travelling in a straight line, upon which the control unit 24 limits or disables the operation of the engine 42A in one of the ways previously described.

In one embodiment, the control unit 24 may limit the operation of the vehicle 12, and more specifically the engine 42A such that the vehicle 12 is only operable for a limited amount of time to allow the driver of the vehicle 12 to reach a safe destination where one or both of the tires 20,22 may be repaired as necessary. Once the limited amount of time has passed, the control unit 24 disables the vehicle 12 such that it is no longer operable.

In another embodiment, the control unit 24 may completely disable the engine 42A the instant an unacceptable amount of tire pressure is in one or both of the tires 20,22. In yet another embodiment, the control unit 24 permits the vehicle 12 to operate until the vehicle 12 has come to a stop, and then prohibits operation of the vehicle 12 until the proper amount of pressure is restored in each of the tires 20,22.

There are also conditions where one or both of the tires 20,22 may suffer catastrophic failure during driving. Under these conditions, if one or both of the sensors 16A,16B detects a sudden and significant drop in tire pressure, indicating that one or both of the tires 20,22 has suffered catastrophic failure. This sudden drop in pressure is signaled to the control unit 18 by the sensors 16A,16B, and the control unit 18 of the TPMS 14 communicates with the control unit 24 of the vehicle 12, and the control unit 24 activates the hazard functions of the rear lights 26 and the front lights 40, indicating to other drivers of other vehicles that the vehicle 12 is in a state of emergency.

Some tire pressure monitoring systems also include the ability to self-inflate the tires of a vehicle while driving. The system 10 of the present invention may also include a tire pump in each of the tires 20,22 to inflate the tires 20,22 in case there is an insufficient amount of pressure in each of the tires 20,22, or one or both of the tires 20,22 suffers from a slow leak. However, if the tire pump in one or both of the tires 20,22 stops working correctly, and one or both of the tires 20,22 continues to leak, the sensors 16A,16B detect the leak, and a signal is received by the control unit 18, which then communicates to the control unit 24 of the vehicle 12, and the control unit 24 commands the warning device 38 to alert the drive of the vehicle 12 that one or both of the pumps inside the tires 20,22 have malfunctioned, or that there is insufficient pressure in one or both of the tires 20,22.

While the vehicle 12 has been described as a motorcycle, it is within the scope of the invention that the system 10 may be incorporated for use with other types of vehicles as well, such as, but not limited to, cars, trucks, sport utility vehicles, tractors, all-terrain vehicles, semi-trucks, and the like.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
a system for providing an indication of insufficient pressure in one or more tires of a vehicle, including:
a tire pressure monitoring system having at least one pressure sensor;
a control unit in communication with the tire pressure monitoring system for receiving a signal from the tire pressure monitoring system;
a plurality of tires, the at least one pressure sensor operable for detecting an undesirable amount of pressure in at least one of the plurality of tires; and
a warning device controlled by the control unit;
wherein the control unit commands the warning device to provide an indication that the pressure in one or more of the plurality of tires is at an undesirable amount of pressure.

2. The apparatus of claim 1, the tire pressure monitoring system further comprising a first control unit in wireless communication with the at least one pressure sensor such that when the at least one pressure sensor detects an undesirable amount of pressure in at least one of the plurality of tires, the sensors send a signal to the first control unit indicating that at least one of the plurality of tires has the undesirable pressure.

3. The apparatus of claim 2, the control unit further comprising a second control unit in communication with the first control unit such that the first control unit communicates to the second control unit that one or more of the plurality of tires has undesirable pressure.

4. The apparatus of claim 1, further comprising a propulsion unit controlled by the control unit, such that when the undesirable pressure is detected in one or more of the plurality of tires, the operation of the propulsion unit limited by the control unit.

5. The apparatus of claim 4, wherein the control unit limits the operation of the propulsion unit to control the speed of the vehicle when the undesirable pressure is detected in one or more of the plurality of tires.

6. The apparatus of claim 4, wherein the control unit limits the operation of the propulsion unit to prohibit operation of the vehicle when the undesirable pressure is detected in one or more of the plurality of tires.

7. The apparatus of claim 4, wherein the control unit allows operation of the propulsion unit until the vehicle comes to a stop, when the undesirable pressure is detected in one or more of the plurality of tires.

8. The apparatus of claim 1, the warning device further comprising:
a visible warning light located in an instrument cluster; and
an alarm sound which is activated simultaneously as the visible warning light to indicate the one or more of the plurality of tires has undesirable pressure.

9. The apparatus of claim 1, wherein the vehicle is one selected from the group consisting of a motorcycle, a car, a truck, a sport utility vehicle, a tractor, an all-terrain vehicle, and combinations thereof.

10. A system for signaling an indication of insufficient pressure in one or more tires of a vehicle, comprising:
a tire pressure monitoring system;
a plurality of pressure sensors, the plurality of pressure sensors being part of the tire pressure monitoring system;
a plurality of tires, each one of the plurality of pressure sensors mounted to a corresponding one of the plurality of tires;
a first control unit which is part of the tire pressure monitoring system, the first control unit in communication with each of the plurality of sensors such that the first control unit receives a signal from one or more of the plurality of pressure sensors indicating that one or more of the plurality of tires has an undesired pressure;
a second control unit in communication with the first control unit, such that the second control unit receives the signal from the first control unit that one or more of the plurality of tires has an undesired pressure;
a warning device controlled by the second control unit, to provide an indication to the driver of the vehicle that one or more of the plurality of tires has an undesired pressure;
at least one light which is capable of functioning as a hazard light, the at least one light being mounted to the vehicle; and
a propulsion unit controlled by the second control unit;
wherein the at least one light is activated to operate as a hazard light by the second control unit when the one or more of the plurality of pressure sensors detects an undesired pressure level in one or more of the plurality of tires.

11. The system for signaling an indication of insufficient pressure in one or more tires of a vehicle of claim 10, wherein one or more of the plurality of sensors is part of the tire pressure monitoring system, and each of the plurality of sensors is in wireless communication with the control unit.

12. The system for signaling an indication of insufficient pressure in one or more tires of a vehicle of claim 10, wherein the second control unit controls the propulsion system to limit the maximum speed of the vehicle.

13. The system for signaling an indication of insufficient pressure in one or more tires of a vehicle of claim 10, wherein the second control unit controls the propulsion system to prohibit operation of the vehicle.

14. The system for signaling an indication of insufficient pressure in one or more tires of a vehicle of claim 10, wherein the second control unit controls the propulsion system to limit the operation of the vehicle until the vehicle is stopped.

15. The system for signaling an indication of insufficient pressure in one or more tires of a vehicle of claim 10, where the vehicle is one selected from the group consisting of a motorcycle, a car, a truck, a sport utility vehicle, a tractor, an all-terrain vehicle, and combinations thereof.

16. The system for signaling an indication of insufficient pressure in one or more tires of a vehicle of claim 10, the warning device further comprising:
a visible warning located in an instrument cluster; and
an alarm sound which is activated simultaneously as the visible warning to indicate the one or more of the plurality of tires.

17. A method for controlling the operation of a vehicle when there is an undesired amount of pressure in a tire, comprising the steps of:
providing a tire pressure monitoring system having a plurality of sensors;
providing a plurality of tires, one of the plurality of sensors for detecting the pressure in one of the plurality of tires;
providing a control unit which is in communication with the tire pressure monitoring system;
providing a warning device controlled by the control unit to indicate that one or more of the plurality of tires has an undesired pressure;
signaling to the tire pressure monitoring system the amount of pressure in each of the plurality of tires using the plurality of sensors; and
limiting the operation of the vehicle once one of the plurality of sensors detects an undesirable amount of pressure in one or more of the tires.

18. The method of claim 17, further comprising the steps of:
providing a first control unit in wireless communication with each of the plurality of sensors, the first control unit being part of the tire pressure monitoring system;
providing the control unit to be a second control unit in communication with the first control unit;
sending first signal from one or more of the plurality of sensors to the first control unit indicating when one or more of the tires is of an undesirable pressure;
sending a second signal from the first control unit to the second control unit, communicating to the second control unit that one or more of the tires is of an undesirable pressure; and
using the second control unit to limit the operation of the vehicle until all of the plurality of tires are of a desired pressure.

19. The method of claim 17, further comprising the steps of:
providing a propulsion unit for delivering power to at least one of the plurality of tires; and
limiting the operation of the propulsion unit with the second control unit to limit the maximum speed of the vehicle.

20. The method of claim 18, further comprising the steps of:
providing the propulsion unit to include an engine and a transmission;
limiting the operation of the engine to a maximum allowable speed, limiting the speed of the vehicle; and
limiting the operation of the transmission to a maximum allowable gear, limiting the speed of the vehicle.

21. The method of claim 19, the further comprising the steps of:
providing at least one light which acts as a hazard light when one or more of the plurality of tires has an undesired pressure; and
controlling the at least one light with the control unit.

22. The method of claim 17, further comprising the steps of:
providing the warning device with a visible warning light located in an instrument cluster; and
providing the warning device with an alarm sound which is activated simultaneously as the visible warning light to indicate the one or more of the plurality of tires has undesirable pressure.
